(19) United States
(12) Patent Application Publication
(10) Pub. No.: US 2022/0135867 A1
(43) Pub. Date: May 5, 2022

(54) CROSSLINKING FLUIDS, METHODS FOR DELAYING GEL CROSSLINKING OF SAID FLUIDS, AND APPLICATIONS OF SAID FLUIDS

(71) Applicant: Cameron International Corporation, Houston, TX (US)

(72) Inventor: Yiyan Chen, Sugar Land, TX (US)

(21) Appl. No.: 17/490,036

(22) Filed: Sep. 30, 2021

Related U.S. Application Data
(60) Provisional application No. 63/107,195, filed on Oct. 29, 2020.

(51) Int. Cl. C09K 8/52; C09K 8/512; C09K 8/514; C09K 8/516; C09K 8/44; E21B 21/00

(52) U.S. Cl. CPC C09K 8/52; C09K 8/512; E21B 21/003; C09K 8/516; C09K 8/44; C09K 8/514

(57) ABSTRACT

Crosslinking fluids and methods configured for delaying gel crosslinking of the crosslinking fluid are provided. The crosslinking fluids and methods comprise mixtures of at least one crosslinking polymer, at least one crosslinker configured for crosslinking the at least one crosslinking polymer, at least one crosslink delay trigger configured for initiating crosslinking at a predetermined pH value and comprising at least one low reactivity magnesium oxide, and polar protic solvent. The at least one low reactivity magnesium oxide is produced by calcination of magnesium carbonate ore or magnesium hydroxide ore at a calcining temperature of at least 1,000° C.

### CROSS REFERENCE TO RELATED APPLICATIONS

The present application claims priority benefit of U.S. Provisional Application No. 63/107,195, filed Oct. 29, 2020, the entirety of which is incorporated by reference herein and should be considered part of this specification.

### BACKGROUND

In applications of gels in oil and gas industry, there are several occasions when gels need to be crosslinked to give good viscoelastic properties as well as saving material cost. For example, gels may be crosslinked for hydraulic fracturing applications to provide good proppant transportation. There are also times when it is not desired to crosslink the gels immediately in the applications for various considerations. For example, non-crosslinked gel fluids have lower viscosity and lower friction losses when pumped in tubular, this can result in horsepower saving when pumping down vertical part of the tubular where proppant transportation property is not critical. There are occasions where crosslinking bonding is irreversible and excessive shear can completely degrade the gels resulting in poor solid carrying ability. Crosslinking in these occasions may only take effect when severe shearing is cleared. There is also known occasions where the pumping equipment cannot suck a polymer gel out of a container if the polymer gel is fully crosslinked; however, delaying the crosslinking of the polymer gels allows otherwise. Yet another situation where the additive cannot be accurately added to a mixing stream when fluid is batch mixed, extra recirculation and time are needed for the additives to be homogeneously dispersed in the whole fluid body. All these occasions require the fluid to have the crosslinking process delayed.

In typical well fracturing applications, the gel crosslinking is usually desired to be fully developed before the fluid reaches the perforation. Since the pumping rate may be in 10s to 100 bbl/min, known crosslinking delays are, at best, usually in the range of 10 seconds to 2 minutes. For this case, these known crosslinking delays are reached by creating some physical barriers to delay two or three chemicals from contacting and/or reacting with each other. One known example is to have the crosslinker in solid form and the time for the solid form to dissolve will provide this known crosslinking delay. This known crosslinking delay may be further extended to have the solid dispersed in an oil-based carrying fluid while the gel is disposed in aqueous phase. There are also occasions that temperature changes are used as triggers to known crosslinking delay. Example of this temperature crosslinking delay can be found in the ThermoFrac® concept wherein the zirconium crosslinking is triggered by the temperature increases as the gel fluid is being pumped down hole and even cleared beyond the perforation. The viscosity of the gel fluid is provided by a transient boron crosslink prior to the zirconium crosslink.

### SUMMARY OF THE DISCLOSURE

In embodiments, crosslinking fluids, methods for delaying gel crosslinking of the crosslinking fluids, and oil and/or gas industry applications of the crosslinking fluids are provided. The crosslinking fluids may comprise a mixture of one or more gelling agents or crosslinking polymers, one or more crosslinkers, one or more crosslink delay triggers, and one or more solvents. In some embodiments, the crosslinking fluids may be water-based fluids and/or may optionally comprise one or more breakers, one or more pH adjustors, and/or one or more pH buffers. The one or more crosslink delay triggers may be configured or adapted for delaying gel crosslink until the pH value of the crosslinking fluids increase above predetermined pH values of about 6.7 or more. Upon gel crosslink of the one or more crosslinkers and one or more gelling agents and/or crosslinking polymers, a gel or a crosslinked or crosslinked fluid may be provided for utilization in one or more applications in the oil and gas industry.

In some embodiments, a crosslinking fluid configured for delaying gel crosslinking of the crosslinking fluid is provided. The crosslinking fluid may comprise at least one crosslinking polymer, at least one crosslinker configured for crosslinking the at least one crosslinking polymer, at least one crosslink delay trigger configured for initiating crosslinking at a predetermined pH value and comprising at least one low reactivity magnesium oxide, wherein the at least one low reactivity magnesium oxide is produced by calcination of magnesium carbonate ore or magnesium hydroxide ore at a calcining temperature of at least 1,000° C., and polar protic solvent.

In an embodiment, a concentration of the at least one crosslinking polymer may be greater than C*, a minimum overlapping concentration, to get crosslinked.

In an embodiment, the at least one crosslinkable polymer may comprise at least one selected from guar, modified guar, guar gum, guaran, carboxymethylguar, hydroxypropylguar, carboxymethyl hydroxypropyl guar, partially hydrolyzed polyacrylamide, and at least one mixture thereof.

In an embodiment, a concentration of the at least one crosslinker may be greater than C*, the minimum overlapping concentration, to crosslink the at least one crosslinking polymer.

In an embodiment, the at least one crosslinker may comprise at least one selected from a borate-type crosslinker, a titanate-type crosslinker, a zirconate-type crosslinker, a zirconate/borate-type crosslinker, and at least one mixture thereof.

In an embodiment, the at least one low reactivity magnesium oxide may be present in the crosslinking fluid at a concentration ranging from about 0.01 to about 0.2 wt. %, based on the total of the crosslinking fluid.

In an embodiment, the at least one low reactivity magnesium oxide may comprise at least one selected from hard burned MgO and dead burned MgO.

In an embodiment, the at least one low reactivity magnesium oxide may comprise both the hard burned MgO and the dead burned MgO.

In an embodiment, the solvent may be at least one solvent selected from water, monoethylene glycol, methanol, ethanol, isopropyl alcohol, and at least one combination thereof.

In some embodiments, methods may delay crosslinking in the crosslinking fluid, according to any of the preceding claims, by maintaining a pH value of the crosslinking fluid below the predetermined pH value.

In an embodiment, the method may trigger crosslinking by increasing the pH value to be greater than the predetermined pH value, wherein the triggered crosslinking produces a crosslinked fluid.

In an embodiment, the predetermined pH value may be about 7.

In some embodiments, methods may prepare a crosslinking fluid by mixing the following components together: at least one crosslinking polymer; at least one crosslinker configured for crosslinking the at least one crosslinking polymer; at least one crosslink delay trigger configured for initiating crosslinking at a predetermined pH value and comprising at least one low reactivity magnesium oxide, wherein the at least one low reactivity magnesium oxide is produced by calcination of magnesium carbonate ore or magnesium hydroxide ore at a calcining temperature of at least 1,000° C. and the predetermined pH value is indicative of at least one of the at least one crosslinking polymer, the at least one crosslinker, and the at least one crosslink delay trigger; and polar protic solvent. The methods may maintain the pH of the crosslinking fluid below the predetermined pH value.

In an embodiment, the at least one low reactivity magnesium oxide of the methods may be present in the crosslinking fluid at a concentration ranging from about 0.01 to about 0.2 wt. %, based on the total of the crosslinking fluid.

In an embodiment, the at least one low reactivity magnesium oxide of the methods may comprise at least one selected from hard burned MgO and dead burned MgO.

In an embodiment, the at least one crosslinking polymer of the methods may comprise at least one selected from guar, modified guar, guar gum, guaran, carboxymethylguar, hydroxypropylguar, carboxymethyl hydroxypropyl guar, partially hydrolyzed polyacrylamide, and at least one mixture thereof, the at least one crosslinker of the methods may comprise at least one selected from a borate-type crosslinker, a titanate-type crosslinker, a zirconate-type crosslinker, a zirconate/borate-type crosslinker, and at least one mixture thereof, and the polar protic solvent of the methods may be one selected from water, monoethylene glycol, and a combination thereof.

In an embodiment, the methods may load the crosslinking fluid into a pigging manifold connected to and in fluid communication with a pipeline.

In an embodiment, the methods may trigger crosslinking of the at least one crosslinking polymer and the at least one crosslinker in the crosslinking fluid by increasing a pH value of the crosslinking fluid to be greater than or equal to about 8.6, wherein the triggered crosslinking produces a pigging gel.

In an embodiment, the methods may introduce the pigging gel from the pigging manifold into the pipeline.

In an embodiment, the methods may clean the pipeline by circulating the pigging gel disposed within the pipeline.

In some embodiments, methods may delay crosslinking of a polymer solution for a duration of delay time by using low reactivity MgO as a crosslink delay trigger, wherein the polymer solution comprises at least a crosslinking polymer and a crosslinker and crosslinking the polymer solution provides a crosslinked fluid.

In an embodiment, the duration of delay time may be adjustable from minutes to tens of hours.

In an embodiment, the methods may crosslink polymer with cis-hydroxyl function group and/or a carboxylate functional group.

In an embodiment, the crosslinking polymer of the methods may comprise guar, HPG, CMC, CMHPG, PHPA, or a combination thereof.

In an embodiment, the crosslinker of the methods may crosslink the polymer solution at higher than neutral pH

In an embodiment, the crosslinker of the methods may comprise B, Zr, Cr, Ti species, or a combination thereof.

In an embodiment, the methods may avoid syneresis of borate crosslinked fluid, wherein the crosslinked fluid consists of the borate crosslinked fluid.

In an embodiment, the methods may introduce the polymer solution and/or the crosslinked fluid into a pipeline.

In an embodiment, the methods may provide a temporary fluid loss or kill pill comprising the polymer solution and/or the crosslinked fluid.

In an embodiment, the pill of the methods may provide long delay to deliver the pill to a predetermined position before the pill becomes unpumpable.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a scatterplot chart illustrating pH value evolvements as two forms of MgO are hydrated in water, according to one or more examples of the disclosure.

FIG. 2 is a scatterplot chart illustrating comparisons of pH evolution of hard burned MgO at various concentrations in gel and in fresh water, according to one or more examples of the disclosure.

FIG. 3 is a scatterplot chart illustrating a comparison of lab and yard tests of the pH evolution of 0.16% hard burned MgO in gel, according to one or more examples of the disclosure.

FIG. 4 is a line chart illustrating crosslinking development of hard burned MgO delayed crosslink gel, according to one or more examples of the disclosure.

FIG. 5 is a line chart illustrating crosslinking development of various forms of MgO used as pH triggers in MEG/water mixed solvent to crosslink CMHPG polymer, according to one or more examples of the disclosure.

FIG. 6 is a line chart illustrating crosslinking development and subsequence syneresis of a hard burned MgO delayed crosslink gel, according to one or more examples of the disclosure.

FIG. 7 is a three-dimensional chart illustrating MgO and Borax concentration ranges of an example 1% crosslinked guar gel, according to one or more examples of the disclosure.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

In one aspect, embodiments disclosed herein relate or are directed to crosslinking fluids and/or crosslinked fluids, methods for preparing the crosslinking fluids and/or crosslinked fluids, and/or methods for utilizing the crosslinking fluids and/or the crosslinked fluids in one or more applications in the oil and gas industry. The crosslinking fluids and/or the crosslinked fluids are configured or adapted to delay gel crosslinking of the crosslinking fluids and/or the crosslinked fluids dependent upon the requirements of the one or more applications. In embodiments, a crosslink delay trigger or pH trigger may initiate or trigger crosslinking when a specific pH value is reached, such as, for example, when the pH value increases to be greater than or equal to about 8.6 or about 8.7. Further, the gel crosslinking may be delay by crosslink delay trigger or pH trigger for a period of time that is greater than or equal to about ten minutes, greater than or equal to about thirty minutes, greater than or equal to about one hour, or greater than or equal to about three hours.

In an example, the crosslinking fluid may comprise one or more crosslinked polymers which may be utilized in the one or more oil and gas industrial applications. The crosslinking fluid and/or the crosslinked fluid may be used at application temperatures ranging from about 0 degree C. (hereinafter “° C.”) to about 90° C. In embodiments, the crosslinking fluid and/or the crosslinked fluid may be usable for one or more pipeline applications at application temperature ranging from about 15° C. to about 45° C. Further, a manageable crosslink delay of the crosslinking fluid and/or the crosslinked fluid may be at a temperature range from about 5° C. to about 40° C. The crosslinking fluid and/or the crosslinked fluid may have a fluid viscosity at 25 s−1 ranging from about 300 to about 16,000 cP, the crosslink delay time may range from about 0.1 hour to about 12.5 hours, an initial crosslink (i.e., lipping) time may range from about 0.1 hour to about 8.5 hours, and/or a strong crosslink time may range from about 0.1 hour to about 12.5 hours. In some embodiments, the crosslink delay time may be less than about 0.1 hour or greater than about 12.5 hours.

In yet another aspect, embodiments disclosed herein relate or are directed to the crosslinking fluid comprising at least one gelling agent and/or crosslinking polymer (hereinafter “the crosslinking polymer”), at least one crosslinker (hereinafter “the crosslinker”), at least one crosslink delay trigger (hereinafter “the delay trigger”), and at least one solvent (hereinafter “the solvent”). In some embodiments, the crosslinking fluid may optionally comprise at least one breaker (hereinafter “the breaker”), at least one pH adjuster (hereinafter “the pH adjuster”), and/or at least one pH buffer (hereinafter “the pH buffer”).

### Crosslinking Polymers

In embodiments, the crosslinking polymer may be a crosslinking and/or food-grade biodegradable polymer and/or configured or adapted such that the resulting crosslinked polymers do not solubilize in hydrocarbons. Further, the crosslinking polymer comprises at least one functional group or two or more functional groups. Further, the crosslinking polymer may be present in the crosslinking fluid at a concentration ranging from about 0.1 to about 2.0 wt. %, from about 0.3 to about 1.7 wt. %, or about 0.5 to about 1.5 wt. %, based on or calculated to a total of the crosslinking fluid. In some embodiments, the concentration of the crosslinking polymer may be greater than or equal to about 0.01 wt. % to less than or equal to about 0.5 or about 1 wt. % based on or calculated to a total of the crosslinking fluid. Further, the concentration of the crosslinking polymer is greater than C*, the minimum overlapping concentration, to get crosslinked. In an embodiment, the crosslinker polymer is crosslinked upon the delay trigger increasing the pH above a threshold pH value and the crosslinking polymer being present at a concentration above a threshold concentration value for the crosslinking polymer.

In embodiments, the crosslinking polymer may be a dry powder polysaccharide and/or have an average molecular weight from, for example, about 1,000,000 to about 2,000,000. In some embodiments, the crosslinking polymer may be or may comprise at least one selected from guar, modified guar, guar gum, guaran, process-enhanced guar, carboxymethylguar (hereinafter “CMG”), hydroxypropylguar (hereinafter “HPG”), carboxymethyl hydroxypropyl guar (hereinafter “CMHPG”), partially hydrolyzed polyacrylamide, and at least one mixture thereof. Further, the guar may contain from about 6 to about 7 wt. % of insoluble material, HPG may contain less than about 3 wt % of insoluble material, and the insoluble material may comprise one or more proteins and/or cellulose. Still further, CMHPG may have about 1 wt % or less insoluble contaminants.

In embodiments, the crosslinking polymer may have no charge, a cationic charge or an anionic charge. For example, guar and HPG may have no charge and CMHPG may have an anionic charge. In some embodiments, the crosslinking polymer may comprise guaran (comprising one or more linear chains of D-mannose resides bonded together by one or more glycosidic linkages) which have a mannose to galactose ratio ranging from about 1.5 to about 2 and/or galactosyl residues randomly arranged in one or more pairs and/or one or more triplets.

### Crosslinkers

In embodiments, the crosslinker may be based on one or more boron compounds and/or one or more zirconium compound or may comprise one or more active species. For example, the active species may be selected from antimony, chromium, titanium or aluminum. In some embodiments, the crosslinker may provide borate functionality and/or may be dissolved in water or other polar solvent. Moreover, the crosslinker may be an inorganic crosslinker and/or may be derived from one or more different types or kinds of oars.

In some embodiments, the crosslinker may be provided in the form of granular solid and/or may be dissolved into water or other polar solvent prior to use. For example, at pH values of greater than or less than about 8.6 caustic environment, the B crosslinker may exist mostly in the species to react with cis-hydroxyl functional groups in multiple polysaccharide chains in solution leading to crosslink. When polysaccharide solution is crosslinked, the fluid viscosity and elasticity may increase drastically resulting in a viscoelastic gel and/or the crosslinked fluid. In an embodiment, the viscoelastic gel and/or the crosslinked fluid may be configured or adapted to provide isolation ability in pipeline applications, such as, for example, gel pigging or the like. In some embodiments, higher pH levels push conversion of boric acid to borate conversion, which provides substantial amounts of crosslinking species to crosslink the polysaccharide solution. For example, a crosslinking polymer of 1% loading may need a pH of 8.6 with borax concentration of 0.04% to show visible crosslinking, but that same crosslinking polymer may be crosslinked at pH 8.4 if the borax concentration is 0.1%. Similarly, 1.5% crosslinking polymer may need or require 0.04% borax and pH 8.2 to be crosslinked.

For transition metal crosslinker, such as, for example, Zr, the crosslink happens on the carboxylate functionality of the polymer, e.g. the carboxymethyl of CMHPG, the hydrolyzed polyacrylate in polyacrylamide. Similarly, the pH increases triggered by the crosslink trigger avail the carboxyl group in carboxylate group from different polymer chains. These carboxylate groups react with the transition metal crosslinker to yield covalent bonding between polymer chains, leading to polymer crosslinking.

The crosslinking by the crosslinker may be reversible which means the crosslink bond(s) may be broken and/or may be reformed repeatedly. As a result, further shearing may not cause permanent damage to the viscoelastic gel and/or the crosslinked fluid. However, for some other crosslinking types, such as, for example, Zr crosslinking, the crosslink bond formation may be irreversible and further shearing of the gel or crosslinked fluid may break the crosslinking bond permanently which leads to the broken of the gel or crosslinked fluid. In this case, further shearing in the mixing not only will not help the blending of the ingredients, it may break the gel or crosslinked fluid permanently.

In embodiments, the crosslinker may be dependent upon, indicative of, or associated with the crosslinking polymer. For example, guar, CMG, HPG, and/or CMHPG crosslinking polymers may be crosslinked by the crosslinker selected from a borate-type, a titanate-type, a zirconate-type, and/or a zirconate/borate-type crosslinker. The crosslinker may bond or crosslink the crosslinking polymer when the pH values of the crosslinking fluid may be less than about 5.0, from about 4 to about 6, or greater than about 8.5. The crosslink activity of the crosslinker may be a function of at least one of pH, temperature, pressure, and/or concentrations of both the crosslinking polymer, the crosslinker, and/or the active crosslinking species. In some embodiments, at least one ion of the crosslinker may form one or more bonds or crosslinks by reacting with one or more cis-diols in the polysaccharide, and/or the carboxylate group of a modified polysaccharide.

An amount of time to bond or crosslink the crosslinking polymer and the crosslinker may be, for example, controlled chemically. The amount of time may be chemically controlled by (i) slowly dissolving salts of the crosslinker, wherein crosslinking may occur with an increase in the temperature, (ii) a capsule encapsulating the crosslinker, wherein the capsule may slowly dissolve with time, (iii) a complex of the crosslinker, which may have the same, similar, or substantially similar effect as slowly dissolving the crosslinker, and/or (iv) slowly dissolving salts or oxide that may increase the pH of the crosslinking fluid when dissolved.

In embodiments, one or more ions of the crosslinker may form one or more reversible bonds or crosslinks with the crosslinking polymer to produce the crosslinked polymers and/or the crosslinked fluid. The one or more reversible bonds or crosslinks may be broken when the pH value is lowered below about 7, when the temperature is increased for an extended period of time, and/or by shearing and diluting the crosslinked fluid at the same or substantially the same time.

The crosslinker may be, for example, borax and/or may be present in the crosslinking fluid at a concentration ranging from about 0.01 to about 0.2 wt. %, from about 0.02 to about 0.1 wt. %, from about 0.03 to about 0.08 wt. %, or from about 0.04 to about 0.06 wt. %, based on or calculated to the total of the crosslinking fluid. In another example, the crosslinker may be Zr and/or may be present at a concentration as high as 0.6% wt. %, based on or calculated to the total of the crosslinking fluid, since the crosslinker is in a solution with chelating agent. In general, if the active content of a crosslinking species of the crosslinker is different, the concentration range of the crosslinker in the crosslinking fluid will be different. The concentration range of the crosslinker may be dependent upon one or more chemicals and/or one or more package utilized with the crosslinker or the crosslinking fluid.

In some embodiments, the concentration of the crosslinker may be for MgO triggered crosslinking, and not stand alone crosslinking. For example, 0.005% borax may crosslink the crosslinking fluid if the pH is high enough, such as, for example, a pH of 9. However, if Mg²⁺ may be present, then at least one syneresis issue may prevent one or more high concentration combinations. Syneresis typically refers to expulsion of a liquid, such as, for example, water molecules from a material. Often, syneresis issues significantly increase the difficulty of maintaining gel stability and result from excessive cross-linking and/or chemical modification during polymer aging.

### Delay Triggers

The delay trigger is magnesium oxide having low reactivity properties (hereinafter “low reactivity magnesium oxide”). The low reactivity magnesium oxide is produced by calcination of magnesium carbonate or magnesium hydroxide ore at high temperature. Calcining at different temperatures creates magnesium oxide with different reactivity. The MgO used in oilfield or oil and gas applications are the reactive species calcining at lower than 1,000° C. This form of MgO immediately dissolves in water or other polar protic solvent once this form of MgO contacts water or other polar protic solvents. Upon dissolution of MgO in water, Mg(OH)₂ is generated and the fluid pH is increased. The increase in pH triggers and/or initiates the bonding or crosslinking of the boron with cis-hydroxyl groups in the polymer molecules. The fluid pH of MgO is, for example, from 9 to 11 depending on the MgO concentration. In another example, increased pH triggers and/or initiates the bonding or crosslinking of Zr with the carboxylate groups in the polymer molecules.

Calcining at temperatures from about 1,000 to about 1,500° C. produces hard burned MgO (hereinafter “HB MgO”), and at temperatures from about 1,500 to about 2,000° C. produces dead burned MgO (hereinafter “DB MgO”). Both HB MgO and DB MgO have low reactivity and are slow in water hydration.

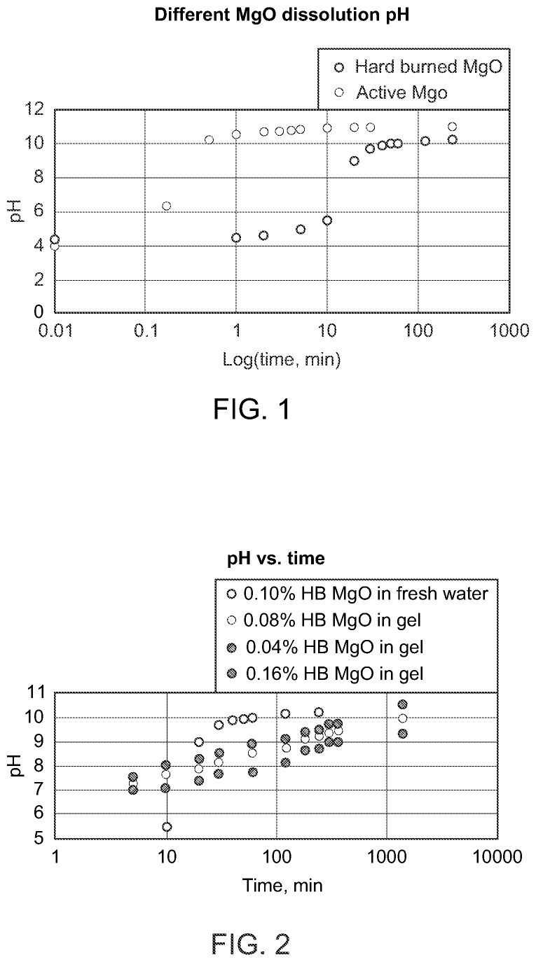

FIG. 1 shows a chart illustrating the pH value evolvements as two forms of MgO, i.e., active MgO and HB MgO, hydrated in water. The solutions were preadjusted to pH ˜4 with acetic acid before about 0.1 wt. % MgO samples were added. Tests were performed at room temperature with a magnetic stirring at about 200 rpm in about 300 mL of deionized (hereinafter “DI”) water. FIG. 1 shows the pH evolvement of two different types of MgO in water. The pH values are preadjusted to weakly acidic and MgO is added to the solution and pH are tracked. As can be seen in FIG. 1, the pH of active MgO solution may reach about 95% of the final pH within a minute, while HB MgO takes about 30 minutes to reach about 95% of the final pH. Both samples were at 0.1 wt. % loading and it is also evident that the final pH for HB MgO reached about 10.2 while for active MgO is about 11.0. This indicates that not only the HB MgO dissolves slower than active MgO, it also has certain amount of the solid stays inactive at high pH. If pH is lower to acidic level, the equilibrium eventually may push the HB MgO to fully activated. The long delay of these high temperature treated MgO (i.e., HB MgO and/or DB MgO) may allow from about several minutes to about a few hours for crosslinking to happen; thus, the long delay may make the gas and oil application with respect to crosslink delay set forth herein feasible or substantially feasible.

In embodiments, the delay trigger may have a specific gravity from about 3.1 to about 4.1, from about 3.3 to about 3.9, from about 3.5 to about 3.7, or of about 3.58. Further, the delay trigger comprising at least one of HB MgO and DB MgO may trigger bonding or crosslinking of the crosslinking polymer by raising the pH values. The delay trigger may trigger bonding or crosslinking at pH values greater than about 8.5. Very high pH values are not preferable for one or more reasons, such as, for example, syneresis and/or shear recovery (i.e., fluid losing viscosity after shear and requiring time to be regained). For syneresis, the pH value may not be problematic; instead, problems may be caused by the [Mg²⁺] in the presence of borate. In an embodiment, the pH value may be less than about 8.6. As a result, effective crosslinking of polysaccharide may immediately begin when the fluid pH of the crosslinking fluid is high enough, such as, for example, greater than about 8.6 or about 8.7. However, this immediate crosslinking may create one or more issues in operation. For example, additives may not be properly dispersed before crosslinking fluid thickens up and/or may prevent further mixing thereof. Therefore, it may be desirable to delay the crosslink to a delayed time when operation may be ready to allow crosslinked gel properties to be developed.

When dissolved in water, the delay trigger comprising HB MgO and/or the DB MgO generates hydroxide ion and renders the crosslinking fluid to be basic. In embodiments, the HB MgO and/or the DB MgO may have retarded reactivity with respect to water. The hydration of the delay trigger may be significantly slowed down so that the fluid pH of the crosslinking fluid increases slowly. Different amounts of the delay trigger may be used to control the crosslink delay time for the crosslinking fluid.

In embodiments, the delay trigger may have dissolution times of greater than about 10 minutes at pH values greater than about 8.0 or greater than about 8.5. In some embodiments, the delay trigger may have dissolution times of less than 1,000 minutes at pH values of less than about 12.0 or less than about 11.0. In some other embodiments, the delay trigger may have dissolution times of greater or equal to about 6 minutes and/or less than or equal to about 3,000 minutes at pH values of greater than or equal to about 7.0 and/or less than or equal to about 11.0. In further embodiments, the delay trigger may have dissolution times of greater than or equal to about 7 minutes and/or less than or equal to about 1,200 minutes at pH values of greater than or equal to about 7.5 and/or less than or equal to about 10.5. In still further embodiments, the delay trigger may have dissolution times of greater than or equal to about 200 minutes and/or less than or equal to about 1,400 minutes or about 1,600 minutes.

In embodiments, the crosslinked polymer synereses if the crosslinker and Mg²⁺ may not be in proper or substantially proper balance. Too much of either the crosslinker or the delay trigger with respect to the crosslinking polymer may lead to syneresis which compromises the fluid isolation capability and/or other fluid properties of the crosslinked

In an example, the delay trigger may be HB MgO and/or DB MgO which may have a MgO minimal content of greater than or equal to about 97.0 wt. % and a calcium oxide content of less than or equal to about 1.0 wt. %, based on or calculated to a total of the delay trigger. Additionally, at least about 96% of the delay trigger may be sized and/or shaped to pass through 325 mesh screen. Further, the release rate of HB MgO for pH values ranging from about 8.6 to about 9.7 may be less than or equal to about 0.5 μM/min. The MgO dissolution in water increase the pH of the crosslinking fluid and converts borax to borate, which crosslinks the crosslinking polymer. Therefore, the MgO minimal content, the calcium oxide content, the mesh value, and/or the pH value may be moving parameter values or targets. For example, mesh size affects the surface area for the dissolution; therefore, larger mesh values (i.e., smaller particles) dissolve faster such that the bonding or crosslinking triggers or initiates faster than larger particles. In contrast, larger particles have a slower dissolution rate such that higher concentrations may achieve the same, or substantially the same, crosslink after proper formulation.

In embodiments, the delay trigger may be present in the crosslinking fluid at a concentration ranging from about 0.01 to about 0.2 wt. %, from about 0.02 to about 0.18 wt. %, from about 0.04 to about 0.16 wt. %, from about 0.08 to about 0.10 wt. %, or greater than, less than, or equal to about 0.05 wt. %, based on or calculated to the total of the crosslinking fluid. In some embodiments, the initial crosslink time for HB MgO may range from about 0.1 hour to about 0.8 hour, from about 0.4 hour to about 1.6 hours, or from about 1.0 hour to about 3.5 hours. Further, a total crosslink time for the crosslinking fluid may range from about 0.1 hour to about 2.5 hours, from 0.1 hour to about 6.2 hours, or from about 1 hour to about 11 hours. Similar to the MgO minimal content, the calcium oxide content, the mesh value, and/or the pH value, the concentration range, initial crosslink time, and/or total crosslink time may be moving parameter values or targets that may be dependent upon the formulation.

### Adjustors and Buffers

In embodiment, the pH adjuster may shift the pH of the crosslinking fluid or crosslinked fluid, may not provide stability in the presence of pH active species or temperature increases, and/or may be selected from sodium hydroxide (NaOH), potassium hydroxide (KOH), and/or hydrochloric acid (HCl). Further, the pH buffer may maintain the pH value in a defined region of the crosslinking fluid or crosslinked fluid and/or work at any pH value throughout the pH scale. In embodiments, the pH buffer may be a buffer solution comprising a salt of a weak acid and its corresponding acid or a salt of a weak base and its corresponding base. For example, the pH buffer may be selected from sodium acetate (NaAc) and acetic acid (HAc) and the pH adjustor may comprise acetic acid (i.e., a 10% acetic acid solution or a 10% NaOH solution).

In some embodiments, one or more acids may be utilized to adjust or decrease the pH value to low or lower to start with which may avoid crosslinking before the desired or necessary duration of time. Acetic acid may be selected and/or used because acetic acid may not lower or decrease the pH too low since acetic acid is a weak acid. In an embodiment, any acid may be used to adjust the pH of the crosslinking fluid. Neat acid or base is not usable because it has higher HSE risk and is easy to over-incorporate or over-include. In another embodiment, any acid or base may be utilized at any concentration to obtain the desirable low pH value.

### Solvents

In embodiments, the solvent disclosed herein is a medium of the polymer solution comprising at least the crosslinking polymer and the crosslinker. The polymer solution may be a gel, such as, for example, linear gel. As the medium of the polymer solution, the solvent dissolves the crosslinking polymer and the crosslinker. However, the solvent should also not interfere with the crosslinker. Therefore, medium of the polymer solution, may be any solvent as known to a skilled artisan that does not interfere with the crosslinker while dissolving the crosslinking polymer and the crosslinker.

The solvent of the crosslinking or crosslinked fluid may be a polar protic solvent. For example, the solvent may be selected from water, monoethylene glycol (hereinafter “MEG”), and a combination thereof. In some embodiments, the solvent may be an organic compound selected from at least on alcohol. For example, the solvent may be selected from methanol, ethanol, isopropyl alcohol, and at least one combination thereof.

### Base fluids

In one or more embodiments, the crosslinking fluid (prior to bonding or crosslinking the crosslinking polymers and the crosslinkers) and/or the crosslinked fluid (subsequent to bonding or crosslinking at least a portion of the crosslinking polymers and at least a portion of the crosslinkers) in accordance with the present disclosure may optionally be incorporated into or added a base fluid. The resulting mixture of the base fluid, the crosslinking fluid, and/or the crosslinked fluid may be utilized in or during the one or more oil and gas industrial applications.

For example, the crosslinking fluid and/or the crosslinked fluid is optionally added to water or a brine used an aqueous base fluid. In one or more embodiments, the aqueous base fluid is brine which may be water comprising an inorganic salt or organic salt. In various embodiments of the base fluid disclosed herein, the brine may include aqueous solutions wherein the salt concentration is less than that of sea water, or aqueous solutions wherein the salt concentration is greater than that of sea water. Salts that may be found in brine include, but are not limited to, sodium, calcium, aluminum, magnesium, zinc, potassium, strontium, and lithium, salts of chlorides, bromides, carbonates, iodides, oxides, phosphates, sulfates, silicates, and fluorides. Salts that may be incorporated in a brine include any one or more of those present in natural seawater or any other organic or inorganic dissolved salts.

In some embodiments, the brine may also comprise an organic salt, such as sodium, potassium, or cesium formate. Inorganic divalent salts that may be present in the base fluid include calcium halides, such as calcium chloride or calcium bromide. Sodium bromide, potassium bromide, or cesium bromide may also be used. The salt may be chosen for compatibility reasons.

In alternative embodiments, the base fluid may be at least one oil-based wellbore fluid. In some embodiments, the oil-based wellbore fluid may be, for example, an invert emulsion containing an aqueous discontinuous phase and an oil-based continuous phase. “Invert emulsion,” as used herein, is an emulsion in which at least one non-oleaginous fluid is the discontinuous phase and at least one oleaginous fluid is the continuous phase.

“Oleaginous fluid,” as used herein, means an oil which is a liquid at about 25° C. and is immiscible with water. Oleaginous fluid may include substances such as hydrocarbons used in the formulation of wellbore fluids such as diesel oil, mineral oil, synthetic oil (including linear alpha olefins and internal olefins, polydiorganosiloxanes, siloxanes or organosiloxanes), ester oils, glycerides of fatty acids, aliphatic esters, aliphatic ethers, aliphatic acetals, or other such hydrocarbons and combinations of these fluids. The concentration of the oleaginous fluid should be sufficient so that an invert emulsion forms. The concentration of the oleaginous fluid may be less than about 99% by volume of the invert emulsion. In one embodiment the amount of oleaginous fluid is from about 30% to about 95% by volume and more particularly about 40% to about 90% by volume of the invert emulsion fluid.

“Non-oleaginous fluid,” as used herein, means any substance that is a liquid at 25° C. and that is not an oleaginous fluid as defined above. Non-oleaginous fluid is immiscible with oleaginous liquid but capable of forming emulsions therewith. Non-oleaginous liquids may include aqueous substances such as fresh water, sea water, brine containing inorganic or organic dissolved salts, aqueous solutions containing water-miscible organic compounds, and mixtures of these. The amount of the non-oleaginous fluid is typically less than the theoretical maximum limit for forming an invert emulsion. Thus, the amount of non-oleaginous fluid is less than about 70% by volume. Preferably, the amount of non-oleaginous fluid ranges from about 1% to about 70% by volume, and more preferably from about 5% to about 60% by volume of the invert emulsion fluid.

Suitable oil-based, synthetic-based, and/or oleaginous fluid for use in wellbore fluids of the present disclosure may be a natural and/or a synthetic oil. In one or more embodiments, the oleaginous fluid may be selected from the group including diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids, similar compounds known to one of skill in the art, and/or mixtures thereof.

Non-oleaginous fluid may, in some embodiments, include at least one of fresh water, sea water, brine, mixtures of water and water-soluble organic compounds, and mixtures thereof. In various embodiments, the non-oleaginous fluid may be a brine, which may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium salts of chlorides, bromides, carbonates, iodides, chlorates, bromates, formates, nitrates, oxides, sulfates, silicates, phosphates, and fluorides. Salts that may be incorporated in a brine include any one or more of those present in natural seawater or any other organic or inorganic dissolved salts. Additionally, brines that may be used in the drilling fluids disclosed herein may be natural or synthetic, with synthetic brines tending to be much simpler in constitution. In one embodiment, the density of the fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium.

### Additives

In one embodiment, the base fluid of the disclosure may further contain other additives and chemicals that are known to be compatible with the crosslinking fluids or crosslinked fluids. In some embodiments, the other additives and chemicals may provide one or more other functionalities to the crosslinking fluid or crosslinked fluid. For example, the other additives and chemicals may comprise at least one scale inhibitor, at least one wetting agent, at least one corrosion inhibitor, or at least one combination thereof.

### The pH Evolution of Reduced Reactivity MgO in Crosslinking Fluids

The HB MgO dissolution and pH change may follow the same or substantially the same or similar trend of that in fresh water when in a crosslinking fluid or gel situation, but may be slightly different as affected by the other components in the crosslinking fluid or crosslinked as well as the physical properties of the gel or crosslinked fluid.

FIG. 2 show a chart illustrating comparisons of pH evolution of HB MgO at various concentrations in gel and in fresh water, wherein the gel or crosslinking fluid contains about 1% guar gum, about 0.5% glut aldehyde, and about 0.1% borax in water. As can be seen in FIG. 2, the pH values for about 0.10% HB MgO in fresh water increase faster than the pH values for about 0.08% HB MgO in gel and for 0.16% HB MgO in gel where the HB MgO hydration happens in polymer gel. Compared in FIG. 2 are also three different HB MgO loadings hydrating in gaur gel condition, wherein higher loading of HB MgO gives higher pH at the same time but all three different HB MgO loadings follow a same or substantially the same or similar trend.

To ensure that the pH evolution at large scale of fluid may be similar to that measured in the lab, a yard test was performed, wherein about 100 gallons of fluid was prepared with field level equipment.

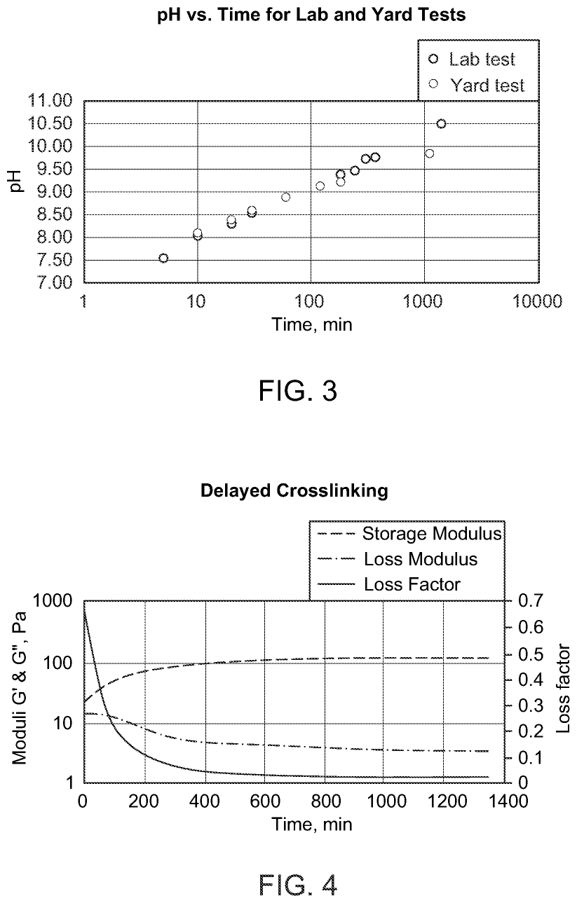

FIG. 3 shows a chart illustrating comparisons of the lab and yard tests of the pH evolution of about 0.16% HB MgO in gel, wherein the gel or crosslinking fluid contains about 1% guar gum, about 0.5% glut aldehyde, and about 0.1% borax in water. The pH evolution of the sample prepared in the yard scale appears to be the same or substantially similar to that of the lab scale as shown in FIG. 3.

### Crosslinking Delay with HB MgO

As disclosed herein, dissolution of MgO in water generates Mg(OH)₂ which may increase the pH of the crosslinking fluid. Further, B(OH)₃ and B(OH)₄⁻ may exist in equilibrium and OH⁻ may drive the equilibrium toward B(OH)₄⁻. In caustic environment, borax exists as borate B(OH)₄⁻. In the presence of B(OH)₄⁻ species, the crosslinking polymer with cis-hydroxyl group in the polymer molecule may be crosslinked. In freshwater environment, a minimum pH value of about 8.6 or about 8.7 may give or provide enough species of B(OH)₄⁻ and bonding or crosslinking of the crosslinking polymer may be visibly observed. Other components may influence this crosslinking point but a change in the minimum pH value may be less than or equal to about 0.2 pH value.

To study the crosslink delay, a crosslinking fluid was prepared by hydrating about 1 wt. % guar gum in freshwater till its viscosity was stable. To avoid the complication of bacteria degradation of the biopolymer guar, about 0.5% glut aldehyde was added to preserve the crosslinking fluid. As the borax solution is normally basic, the pH of the crosslinking fluid was adjusted to ˜6 with acetic acid so that the crosslinking fluid would not be crosslinked immediately when about 0.08 wt. % borax (used in about 5 wt. % aqueous solution) was added. The pH was ensured to be neutral or weakly acidic (pH ˜6) after borax was added. A pre-weighed powder HB MgO (about 0.08 wt. %) was added to the crosslinking fluid in a Waring blender and the crosslinking fluid was blended vigorously for about 30 seconds. To track the crosslink progress quantitatively, dynamic rheology measurement was used to trace the elastic (also called storage) modulus G′ and viscous (also called loss) modulus G″ development at about 1 Hz oscillatory frequency. The amplitude of the oscillation is set to about 10%, which is in the linear deformation region. After the Waring blender mixing, the crosslinking fluid was immediately loaded to the rheometer and measurement was started.

FIG. 4 shows a chart illustrating crosslinking development of the HB MgO delayed crosslink gel or crosslinking fluid, wherein the gel or crosslinking fluid contains about 1% guar, about 0.5% glut aldehyde, about 0.08% borax, and about 0.08% HB MgO in water and the test condition was about 25° C., about 10% amplitude at about 1 Hz frequency. One prominent change in FIG. 4 is the elastic modulus G′, since the crosslinking fluid was becoming more solid like as crosslink was developed, hence higher G′ was observed. The elastic modulus G′ increased with time and reached plateau at about 10 hours. As the elastic modulus is the indication of degree of crosslink of the polymer; hence, the delayed crosslinking was demonstrated. Loss factor (also called tan (phase angle)), which is the ratio of loss modulus and storage modulus, can also be used to track the crosslinking evolution in the crosslinking fluid. Loss factor decreased as crosslink happened since the storage modulus became more and more dominant.

The use of HB MgO and/or DB MgO to delay the crosslinking or gelling of the crosslinking fluid may be applied in other polar protic solvents in addition to water. In example pipeline cleaning applications, if the product being transported via the pipeline is methane, substantial care should be taken to avoid gas hydrate from forming. Large percentage of water needs to be or must be avoided when using gel pigging for natural gas pipelines. MEG may be used in pure or in greater than or equal to about 40 vol. % with water. Boron crosslinked polysaccharide is not applicable in this solvent as borate cannot distinguish between the cis-hydroxyl group of MEG or of the crosslinking polymer. In addition, Guar cannot even be hydrate in the presence of high MEG concentrations, let alone crosslink. Other polysaccharide, such as, for example, CMHPG can be hydrated in MEG/water, whose carboxylate group can be crosslinked by zirconium crosslinker with the trigger of regular or low reactivity MgO in similar fashion.

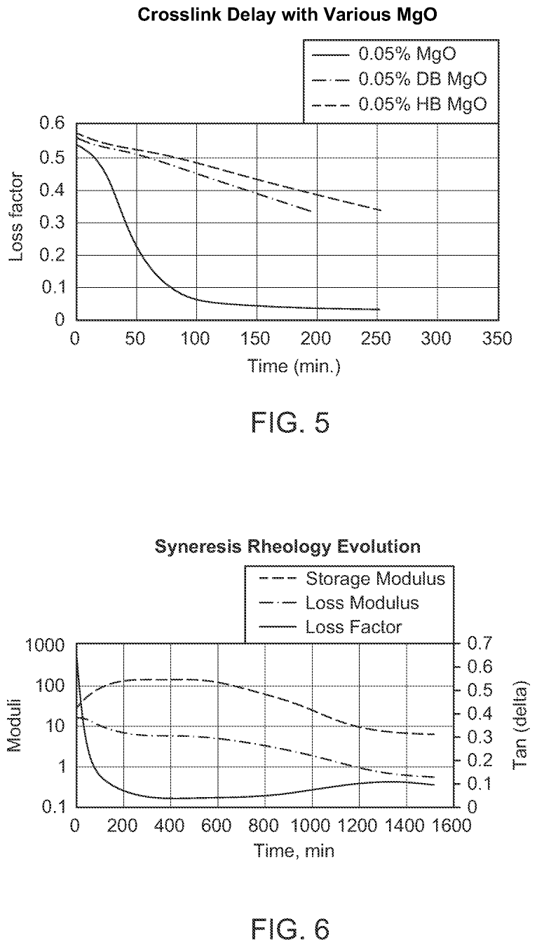

FIG. 5 shows a table illustrating crosslinking development of CMHPG polymer with various forms of MgO used as pH triggers (i.e., the delay trigger) in MEG/water mixed solvent or medium, wherein the gel or crosslinking fluid contains about 1% CMHPG, about 0.01% zirconium lactate, and various MgO in 1/1 (by volume) monoethylene glycol (MEG) water mixture and the test condition was about 25° C., about 10% amplitude at about 1 Hz frequency. FIG. 5 shows that the MgO crosslink delays work well or substantially well for 1/1 MEG/water mixed solvent gel or crosslinking fluid. As shown in FIG. 5, normal (active) MgO did not provide much delay as indicated by the loss factor. Both HB MgO and DB MgO provided extended delays to the bonding or crosslinking of the crosslinking polymer in the MGE-water mixed solvent. As set forth herein, FIG. 5 illustrates the effectiveness of low reactivity MgO to delay crosslink in MEG/water medium, that the concept also works for Zr crosslinker with carboxylate functioned polymer, and that multiple forms of MgO (and the combination of) can be used to reach different levels of delay.

Although the examples set forth herein show use single type of MgO (i.e., HB MgO or DB MgO) in each example formulation, it is understood that the combination of various forms of MgO (i.e., low reactivity MgO, HB MgO, DB MgO, or a combination thereof) with other caustic species may be utilized in the crosslinking fluid to fine tune and/or adjust the crosslink delay with respect to the crosslinking fluid and/or the final crosslinked fluid properties of the gel or crosslinked fluid such that the gel or crosslinked fluid may achieve substantially improved performance results with respect to the one or more oil and gas industrial applications. In an embodiment, the application may be a low temperature application, the solvent may have a higher MEG content, and the combination of MgO may comprise low reactivity MgO because HB MgO and DB MgO have too slow of a hydration rate in higher MEG content containing solvent.

### Syneresis of Boron Crosslinking in the Presence of Magnesium

Boron crosslinked cis-hydroxyl polymers are known to have syneresis behaviour when over-crosslinking happens or occurs. This syneresis behaviour is a phenomenon that the crosslinking fluid is originally crosslinked to a homogeneous gel but with time, the boron crosslink causes the three-dimensional (hereinafter “3-D”) polymer network to contract and expel water. The end result is the fluid phase separates such that a crosslinked gel floats in a mildly thickened water. This is not preferred in operations where the continuum of a gel or crosslinked fluid may be required for the oil and gas application, and any syneresis behaviour with respect to the crosslinking fluid or crosslinked fluid should or must be reduce and/or prevented.

FIG. 6 shows a chart illustrating crosslinking development and subsequence syneresis of a HB MgO delayed crosslink gel, wherein the gel or crosslinking fluid contains about 1% guar, about 0.5% glut aldehyde, about 0.10% borax, and about 0.16% HB MgO in water and the test condition was about 25° C., about 10% amplitude at about 1 Hz frequency. In addition to being influenced by the B(OH)₄⁻ concentration as determined by the concentration of the boron species and the pH value, multivalent ions may increase or exacerbate the syneresis behaviour of the crosslinking or crosslinked fluid. Using MgO to adjust the pH values may have syneresis behaviour or issue if not formulated properly. As shown in FIG. 6, the dynamic fluid rheology was tracked for a crosslinking guar formulation having high concentrations of both HB MgO present at about 0.16% and borax present at about 0.10%. The fluid G′ increased in about the first 200 minutes, then the fluid G′ stayed plateau for about the next 250 minutes, but the fluid G′ started to decrease after about 450 minutes. This decreased fluid G′ is because after about 450 minutes, the fluid syneresis of the gel or crosslinked fluid has begun to happen, water has been bleeding out of the 3-D polymer network, and/or has made a slippery layer of the crosslinked gel float in the mildly thickened water. As a result, the rheology properties of the gel or crosslinked fluid may decrease.

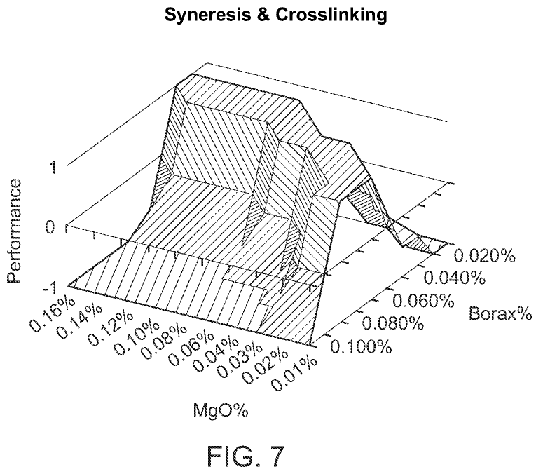

FIG. 7 shows a 3-D chart illustrating the acceptable MgO and borax concentration ranges of an about 1% crosslinked guar gel example. Only the flat surface at the peaks of the elevations (adjacent to or at about Performance=1) of MgO and borax combinations are usable to obtain or produce a reliable gel or crosslinked fluid. To the front of the flat surface, the gel or crosslinked fluid may have syneresis, and, to the back of the flat surface, the gel elasticity of the gel or crosslinked fluid may not be strong enough (i.e., lack of crosslink). It is desirable to have enough B(OH)₄⁻ species to give or produce a strong enough crosslinked fluid but also to avoid the syneresis behaviour or issue with respect to the gel or crosslinked fluid. It is desirable and substantially important to avoid, or substantially avoid the syneresis behaviour or issue. For example, if severe syneresis behavior or issue happen or occur, then the crosslinking polymer and the crosslinker may not be crosslinked and/or one or more operational field failures may happen or occur.

It is understood that based on the boric acid to borax equilibrium and the concentration of the base, the concentration of B(OH)₄⁻ species may be precisely calculated; however, this calculation may not account for the syneresis promoted by divalent ion, as well as any pH buffering effect of the polysaccharide. Complex modelling may be done if all related and/or relevant parameters may be collected and inputted into the calculation to get refined result; however, at predetermined times it may be easier and/or more accurate to map out in, with one or more lab formulation, the region that both good or excellent crosslink and no or reduced syneresis occur. FIG. 7 shows an example of this mapped out formulation for an about 1% crosslinked guar gel. In FIG. 7, the flat surface of MgO and borax concentrations are safe and/or acceptable concentrations that achieved or produced a good or excelled crosslinked gel or crosslinked fluid.

### Oil and Gas Industrial Applications

The crosslinking fluids and/or the crosslinked fluids disclosed herein may be useful for or utilized in at least one oil and gas industrial application and may achieve substantially improved results with respect to the at least one oil and gas industrial application. The at least one oil and gas industrial application may be selected from a downhole application, a wellbore fluid application, a fluid fracturing application, a pipeline application, or at least one combination thereof. The crosslinking fluids and/or crosslinked fluids presently disclosed herein achieve surprising and unexpected performance results with respect to the at least one oil and gas industrial application.

In some embodiments, delay crosslinking approach provided by the crosslinking fluids and/or crosslinked fluids set forth in the present disclose may achieve substantially improved performance results for a gel pipeline application, such as, for example, a gel pigging application in the midstream (i.e., pipeline) market. In a formal pipeline application, there is a pig launching setup where fluids and tools will be loaded into a pipeline with specific sequences and/or procedures. For example, for a sonic leak detection service when pigging gel is used, the gel pig provided by the presently disclosed crosslinking fluid is utilized as a medium for encapsulating a sonic tool for transmitting signals in a homogeneous medium. Alternatively, other mediums besides pigging gel may utilized for sonic leak detection service; however, utilization of gel will demand less volume to a guaranteed full enclosure. In other examples, when issues in the pipeline design (e.g. reduced cross-section diameter of the pipeline) prevent the use of a mechanical pig, the gel pig provided by the presently disclosed crosslinking fluid may be loaded with a small pump (which cannot handle crosslinked fluids) into the launching setup manifold and may be pushed or circulated into and/or disposed within the pipeline. Subsequently, the sonic tool may be launched into the pipeline, and another segment of the pigging gel provided by the presently disclosed crosslinking fluid may be injected into the pipeline. As a result, servicing and/or cleaning of the pipeline may now be ready to be started and/or the gel or crosslinking fluid may now be ready to be crosslinked or crosslinked to produce the gel or crosslinked fluid (i.e., pigging gel). During launching processes of the pigging gel, many operations need to be performed and/or completed (e.g. bleeding of the line, changing of valve setting to provide controlled flowing, etc.) which may take an extended period of time, such as, for example, greater than or about equal to about an hour. Unlike pumping down hole, the temperature of the gel pigging operation may remain constant or substantially constant, and the crosslink delay of the crosslinking fluid may be an order(s) of magnitude longer where normal phase barrier cannot handle.

Another oil and gas industrial application that takes advantage of the improved long-time crosslink delay achievable by the presently disclosed crosslinking fluid and/or crosslinked fluid may be as follows. During a batch preparation of the crosslinking fluid, with the limitation of equipment, the crosslinking fluid may be prepared by recirculating the crosslinking fluid with a c-pump and a tote; however, there may be no accurate metering of an addition rate of the additives, fluid components, and/or chemicals. If crosslinking happens immediately or right after fluid components and/or chemicals of the crosslinking fluids come into contact each other, then two incidents may happen that may give, produce, and/or prepare a crosslinking fluid having one or more poor or inferior qualities. First, the instantaneous crosslinking will generate a very thick gel or crosslinked fluid that may not be pumpable by the pump. Second, the crosslinked fluid being crosslinked may only be a small portion of a total of the crosslinking fluid and the rest of, or the remaining portion of, the crosslinking fluid may not be crosslinked. The batch mixing recirculation may normally require rolling of 5-10 tank volumes of the crosslinking fluid to get the crosslinking fluid to be homogeneous. For example, a period of time to sufficiently complete the batch mixing recirculation may about ten minutes or more. Delaying bonding or crosslinking of the crosslinking polymer and the crosslinker to about an hour or more may allow the crosslinking fluid to be properly and/or homogeneously mixed and the subsequent crosslink or gelling of the crosslinking fluid may happen reliably after completion of the batch mixing recirculation to produce the gel or crosslinked fluid.

Yet another oil and gas industrial application that takes advantage of the improved long-time crosslink delay achievable by the presently disclosed crosslinking fluid and/or crosslinked fluid may provide a temporary isolation plug for wellbore applications. The temporary isolation plug may be a fluid loss pill for drilling and/or fracturing applications. In embodiments, the temporary isolation plug may block one or more perforations in fracturing treatments and/or isolate at least one production zone so that other zones may be treated. In some examples, a delayed gel provided by the crosslinking fluid may be spotted downhole at low viscosity and allowed to crosslink to yield a strong gel for isolation prior to performance of at least one desired treatment. After completion of the at least one desired treatment, the gel may be broken by soaking or recirculating acid therein and/or removed from the wellbore.

In yet another aspect, the embodiments disclose hereinafter relate or are directed to one or more methods of delaying gel crosslink times of the crosslinking fluids by tens of minutes to a few hours after the fluid components and/or chemicals have been added, combined, and/or mixed together. This long-time crosslink delay may be achieved by utilizing and incorporating the low reactivity magnesium oxide (e.g. HB MgO and/or DB MgO) into the crosslinking fluid to slowly dissolve in solvent to adjust pH for crosslinking the crosslinking polymer and the crosslinker of the crosslinking fluid. The one or more methods may introduce or circulate the crosslinking fluid into a portion of a pipeline for one or more midstream pipeline gel pigging applications. After being disposition, the crosslinking fluid may be loaded into a launching and/or pigging manifold for a loading time period before an actual gel pigging operation may be initiated or commenced. In embodiments, the loading time period may be up to about an hour or more. The crosslink delay provided by the crosslinking fluid may allow uncrosslinked pigging gel (i.e., the crosslinking fluid) to be charged with low horsepower pumping equipment and/or may avoid shear degradation when there may be excessive geometry change in the launching and/or pigging manifold.

Other methods disclosed herein may comprise mixing and/or preparing crosslinked gel (i.e., the crosslinked fluids), wherein the crosslink delay of the crosslinking fluid may allow easy and reliable dispersing of the crosslinker and/or the delay trigger in a thin linear gel with minimal horsepower requirement and/or may allow for crosslinking of the crosslinking polymer and the crosslinker to initiate and/or develop while the crosslinking fluid may be disposed or stored within a container, such as, for example, the pipeline, the launching and/or pigging manifold, or a vessel.

The crosslinking fluids and crosslinked fluids disclosed herein comprise forms of magnesium oxide which have much slower dissolution rate in water and/or other polar protic solvents. The low reactivity magnesium oxide is produced by calcination of magnesium carbonate or magnesium hydroxide at high temperature. Calcining at different temperatures creates the low reactivity magnesium oxide with different reactivity, such as, for example, HB MgO and DB MgO. Both HB MgO and DB MgO have low reactivity and are slow in water hydration. Upon dissolution of HB MgO and/or DB MgO in water, Mg(OH)₂ is created and the pH of the crosslinking fluid is increased. As a result, crosslinking of the crosslinking polymer and the crosslinker is triggered and formation of the gel or crosslinked fluid is initiated. The crosslink delay may allow from about ten minutes to about one or more hours for the crosslinking to commence, happen and/or be completed; thus, the crosslink delay of the crosslinking fluid makes the oil and gas industry applications disclosed herein reliable and feasible.

Although only a few example embodiments have been described in detail above, those skilled in the art will readily appreciate that many modifications are possible in the example embodiments without materially departing from this disclosure. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A crosslinking fluid configured for delaying gel crosslinking of the crosslinking fluid, the crosslinking fluid comprising:
at least one crosslinking polymer;
at least one crosslinker configured for crosslinking the at least one crosslinking polymer;
at least one crosslink delay trigger configured for initiating crosslinking at a predetermined pH value and comprising at least one low reactivity magnesium oxide, wherein the at least one low reactivity magnesium oxide is produced by calcination of magnesium carbonate ore or magnesium hydroxide ore at a calcining temperature of at least 1,000° C.; and
polar protic solvent.

2. The crosslinking fluid according to claim 1, wherein a concentration of the at least one crosslinking polymer is greater than C*, a minimum overlapping concentration, to get crosslinked.

3. The crosslinkable fluid according to claim 1, wherein the at least one crosslinkable polymer comprises at least one selected from guar, modified guar, guar gum, guaran, carboxymethylguar, hydroxypropylguar, carboxymethyl hydroxypropyl guar, partially hydrolyzed polyacrylamide, and at least one mixture thereof.

4. The crosslinkable fluid according to claim 1, wherein a concentration of the at least one crosslinker is greater than C*, the minimum overlapping concentration, to crosslink the at least one crosslinking polymer.

5. The crosslinking fluid according to claim 1, wherein the at least one crosslinker comprises at least one selected from a borate-type crosslinker, a titanate-type crosslinker, a zirconate-type crosslinker, a zirconate/borate-type crosslinker, and at least one mixture thereof.

6. The crosslinking fluid according to claim 1, wherein the at least one low reactivity magnesium oxide is present in the crosslinking fluid at a concentration ranging from about 0.01 to about 0.2 wt. %, based on the total of the crosslinking fluid.

7. The crosslinking fluid according to claim 1, wherein the at least one low reactivity magnesium oxide comprises at least one selected from hard burned MgO and dead burned MgO.

8. The crosslinking fluid according to claim 1, wherein the at least one low reactivity magnesium oxide comprises both the hard burned MgO and the dead burned MgO.

9. The crosslinking fluid according to claim 1, wherein the solvent is at least one solvent selected from water, monoethylene glycol, methanol, ethanol, isopropyl alcohol, and at least one combination thereof.

10. A method comprising:
preparing a crosslinking fluid by mixing the following components together:
at least one crosslinking polymer;
at least one crosslinker configured for crosslinking the at least one crosslinking polymer;
at least one crosslink delay trigger configured for initiating crosslinking at a predetermined pH value and comprising at least one low reactivity magnesium oxide, wherein the at least one low reactivity magnesium oxide is produced by calcination of magnesium carbonate ore or magnesium hydroxide ore at a calcining temperature of at least 1,000° C. and the predetermined pH value is indicative of at least one of the at least one crosslinking polymer, the at least one crosslinker, and the at least one crosslink delay trigger; and
polar protic solvent; and
maintaining the pH of the crosslinking fluid below the predetermined pH value.

11. The method according to claim 10, wherein:
the at least one crosslinking polymer comprises at least one selected from guar, modified guar, guar gum, guaran, carboxymethylguar, hydroxypropylguar, carboxymethyl hydroxypropyl guar, partially hydrolyzed polyacrylamide, and at least one mixture thereof;
the at least one crosslinker comprises at least one selected from a borate-type crosslinker, a titanate-type crosslinker, a zirconate-type crosslinker, a zirconate/borate-type crosslinker, and at least one mixture thereof; and
the polar protic solvent is one selected from water, monoethylene glycol, and a combination thereof.

12. The method according to claim 10, further comprising:
loading the crosslinking fluid into a pigging manifold connected to and in fluid communication with a pipeline.

13. The method according to claim 10, further comprising:
triggering crosslinking of the at least one crosslinking polymer and the at least one crosslinker in the crosslinking fluid by increasing a pH value of the crosslinking fluid to be greater than or equal to about 8.6, wherein the triggered crosslinking produces a pigging gel.

14. The method according to claim 10, further comprising:
introducing the pigging gel from the pigging manifold into the pipeline.

15. The method according to claim 10, further comprising:
cleaning the pipeline by circulating the pigging gel disposed within the pipeline.

16. A method comprising:
delaying crosslinking of a polymer solution for a duration of delay time by using low reactivity MgO as a crosslink delay trigger, wherein the polymer solution comprises at least a crosslinking polymer and a crosslinker and crosslinking the polymer solution provides a crosslinked fluid.

17. The method according to claim 16, wherein the duration of delay time is adjustable from minutes to tens of hours.

18. The method according to claim 16, wherein the crosslinking polymer with cis-hydroxyl function group and/or a carboxylate functional group.

19. The method according to claim 16, wherein the crosslinking polymer comprises guar, HPG, CMC, CMHPG, PHPA, or a combination thereof.

20. The method according to claim 16, wherein the crosslinker crosslinks the polymer solution at higher than neutral pH

21. The method according to claim 16, wherein the crosslinker comprises B, Zr, Cr, Ti species, or a combination thereof.

22. The method according to claim 16, further comprising:
avoiding syneresis of borate crosslinked fluid, wherein the crosslinked fluid consists of the borate crosslinked fluid.

23. The method according to claim 16, further comprising:
introducing the polymer solution and/or the crosslinked fluid into a pipeline.

24. The method according to claim 16, further comprising
providing a temporary fluid loss or kill pill comprising the polymer solution and/or the crosslinked fluid.

25. The method according to claim 16, wherein the pill provides long delay to deliver the pill to a predetermined position before the pill becomes unpumpable.
